(19) United States
(12) Patent Application Publication
(10) Pub. No.: US 2024/0047094 A1
(43) Pub. Date: Feb. 8, 2024

(54) TARGET IRRADIATON SYSTEM AND AN EFFECTOR FOR THE SAME

(71) Applicant: isoSolutions Marketing and Management Inc., Vancouver (CA)

(72) Inventor: William GELBART, Garden Bay (CA)

(73) Assignee: isoSolutions Marketing and Management Inc., Vancouver (CA)

(21) Appl. No.: 18/366,253

(22) Filed: Aug. 7, 2023

Related U.S. Application Data
(60) Provisional application No. 63/395,858, filed on Aug. 7, 2022.

(51) Int. Cl. G21K 5/08; G21G 1/00

(52) U.S. Cl. CPC G21K 5/08; G21G 1/00

(57) ABSTRACT

A target irradiation system and an effector of the same for applying a sealing force on to an irradiation target are disclosed. A platen for pressing against the irradiation target is forced upon by a column receiving the sealing force, via an orbicular surface to facilitate angular positioning of the column relative to the platen. A collar surrounds the column and is attached thereto and to the platen. The collar is resiliently deformable to, while allowing the sealing force to be transmitted on to the platen via the orbicular surface, force the platen against the irradiation target to facilitate angular alignment of the platen and the irradiation target. Fluid conduits in the effector may fluidly communicate with cooling channels in the irradiation target to provide cooling using coolant and to allow suction of the irradiation target by the effector by depressurization of the conduits when sealed against the cooling channels.

### CROSS-REFERENCE TO RELATED APPLICATIONS

This application claims the benefit of and priority to U.S. Provisional Application No. 63/395,858, filed on 7 Aug. 2022. The aforementioned application is incorporated by reference herein in its entirety, and is hereby expressly made a part of this specification.

### TECHNICAL FIELD

The disclosure relates generally to systems and method for producing radioisotopes, and more particularly to target irradiation systems for solid targets.

### BACKGROUND

Radioactive elements for medical diagnostic imaging and therapy applications are created by bombarding a chemical element with energetic protons or particles, thereby inducing a nuclear reaction resulting in the creation of the required radionuclide. The source of the particles used to bombard the element is a particle accelerator, which is in most installations a cyclotron. In all cases the acceleration of the particles takes place under high vacuum with pressures below 5×10⁻⁶ torr and with the entire acceleration region of the accelerator enclosed in an evacuated chamber.

The precursor element of the radionuclide is typically solid. To facilitate the handling of solid materials the accepted practice is depositing a relatively thin layer (typically 0.01 mm to 0.5 mm) of the materials on a metallic substrate (usually on a copper or silver wafer or plate, but other materials may be used as well), together forming what is known as a “solid target” (referred to as the irradiation target here). By the target material being clad on or attached to a substrate the solid target can be handled and remotely manipulated when placed in a position for irradiation and when removed from the irradiation position to be transferred for the removal or dissolution of the target material from the substrate in order to separate the produced radionuclide.

In particle accelerators, the accelerated high energy particle beam is deflected or extracted from the accelerating region to be delivered to the target that is placed in an irradiation chamber external to the accelerator. The integrity of the high vacuum must be maintained inside the accelerator as well as through the entire path of the particle beam trajectory up to and including the irradiation target. To maintain this integrity, the particle beam is delivered to the target irradiation enclosure through an evacuated pipe, known as a “beamline”. During the target irradiation the irradiation chamber must as well be evacuated to a (low) pressure, e.g. in the same range as the accelerator and the beamline pressure.

In some instances, the beamline may be a round pipe with the inside diameter of 25 mm to 250 mm and a length of 1 m to 10 m. The particle beam inside the beamline is often subjected to magnetic steering and focusing by electromagnets placed around and along the beamline. It is common as well to collimate the beam before it is reaching the target. The collimator consists of an aperture or of series of slits to shape (by shadowing) the beam to correspond to the target size. Since the collimation is achieved by absorbing a the portion of the beam energy, the collimating elements are cooled (usually by internal water flow or other coolant flow) to remove the heat generated by the absorbed portion of the beam. In many target irradiation systems the collimator is an integral part of the system and placed directly in front of the irradiation target. An irradiation target with a coating of the target material is placed in the target irradiation chamber before irradiation and removed therefrom at the end of the irradiation (for the target material dissolution and processing).

Due to the need for vacuum conditions and substantial potential harmful impact of contamination, remote or otherwise robotic manipulators are often used to transfer irradiation targets on to the irradiation chamber. Such robotic systems have been discussed in non-patent and scientific literature. One such example is disclosed in the journal article: Gelbart, W. Z., & Johnson, R. R. (2019). Solid target system with in-situ target dissolution. Instruments, 3(1), 14.

The end effectors of such manipulators are desired to reliably hold on to irradiation targets without damaging them. Furthermore, it is desired that manipulator facilitate alignment of an irradiation target for proper full-face sealing of the same against the irradiation chamber and, in some cases where coolant-based cooling of irradiation targets is provided by the effector, against the effector as well. It is desired to achieve such and similar objectives using cost-effective, robust, and conveniently manufacturable mechanisms.

### SUMMARY

In some aspects, the disclosure describes an effector of a target irradiation system, the effector operable to apply a sealing force on to an irradiation target. The effector also includes a platen operable to press against the irradiation target; a column receiving the sealing force and being positioned to press onto the platen, via an orbicular surface to facilitate positioning of the column relative to the platen, to transmit the sealing force on to the irradiation target; and a collar receiving the column to surround the column, the collar attached to the column and the platen and being resiliently deformable so as to, while allowing the sealing force to be transmitted on to the platen via the orbicular surface, force the platen against the irradiation target to facilitate alignment of the platen and the irradiation target.

In some aspects, the disclosure describes a target irradiation system. The target irradiation system also includes an irradiation chamber defining an opening configured to receive an inner face of an irradiation target to seal the irradiation chamber and allow a beam to irradiate the irradiation target; and an effector operable to effect a sealing force on to the irradiation target to sealingly engage the irradiation target with the opening of the irradiation chamber, the effector including a platen engaging with an outer face of the irradiation target to press the inner face of the irradiation target against the opening of the irradiation chamber, the inner face and the outer face of the irradiation target being opposite to each other, a column receiving the sealing force and being positioned to press onto the platen, via an orbicular surface to facilitate positioning of the column relative to the platen, to transmit the sealing force on to the irradiation target, and a collar receiving the column to surround the column, the collar attached to the column and the platen and being resiliently deformable so as to, while allowing the sealing force to be transmitted on to the platen via the orbicular surface, force the platen against the opening of the irradiation chamber via the irradiation target to facilitate alignment of the platen and the irradiation chamber to seal the inner face of the irradiation target against the irradiation chamber.

In some aspects, the disclosure describes a method of operating a target irradiation system. The method also includes transmitting a sealing force from a column to a platen via an orbicular surface, the platen being engaged with an irradiation target to press the irradiation target against an opening of an irradiation chamber, the column being engagingly received in a collar that is attached to the platen; and while transmitting the sealing force from the column to the platen via the orbicular surface, moving the column relative to the platen along the orbicular surface to resiliently deform the collar to cause the collar to push on the platen to align the platen and the opening of the irradiation chamber to cause the irradiation target to sealingly engage with the irradiation chamber.

In some aspects, the disclosure describes a method of operating a target irradiation system. The method also includes disposing an effector against an irradiation target to form a coolant passage extending between at least one conduit of the effector to a cooling channel of the irradiation target; supplying coolant to the cooling channel of the irradiation target via the coolant passage to cool the irradiation target; evacuating coolant from the coolant passage via a conduit of the at least one conduit; and depressurizing the coolant passage to cause suction between the irradiation target and the effector to support the irradiation target on the effector.

In some aspects, the disclosure describes a target irradiation system. The target irradiation system also include an irradiation chamber configured to receive an irradiation target; an effector configured to engage with the irradiation target to move the irradiation target and to cool the irradiation target while the irradiation target is being irradiated in the irradiation chamber, the effector defining at least one conduit fluidly communicating with at least one cooling channel of the irradiation target to form at least one coolant passage extending between the effector and the irradiation target; at least one valve connected to the effector to selectively flow fluids through the at least one conduit; and circuitry operably connected to the one or more valves and configured to cause supplying of coolant to the cooling channel of the irradiation target via the at least one coolant passage to cool the irradiation target, cause evacuation of coolant from the at least one coolant passage via the at least one conduit of the effector, and cause depressurizing of the at least one coolant passage to cause suction between the irradiation target and the effector to support the irradiation target on the effector.

Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a perspective view of a target irradiation system 100, in accordance with an embodiment.

FIG. 2 is a partial sectional perspective view of an embodiment of the target irradiation system, showing a sectional through the irradiation chamber as it engages with an effector;

FIG. 3A is a perspective view of an effector in position to engage with an irradiation target, in accordance with an embodiment;

FIG. 3B is rear elevation view of the effector in position to engage with the irradiation target, in accordance with an embodiment;

FIG. 4A is a perspective view of a target irradiation system engaged with an irradiation target, in accordance with an embodiment;

FIG. 4B is a side elevation view of the target irradiation system of FIG. 4A, in accordance with an embodiment;

FIG. 4C is bottom plan view of the target irradiation system of FIG. 4A, in accordance with an embodiment;

FIG. 5A is a cross-sectional view along the line 5A-5A in FIG. 4B;

FIG. 5B is a cross-sectional view along the line 5B-5B in FIG. 4B;

FIG. 5C is a cross-sectional view along the line 5C-5C in FIG. 4C;

FIG. 6A is a plan view of a collar, in accordance with an embodiment;

FIG. 6B is a perspective view of the collar of FIG. 6A;

FIG. 7A is a plan view of a collar, in accordance with an embodiment;

FIG. 7B is a perspective view of the collar of FIG. 7A;

FIG. 7C is a perspective view of the collar of FIG. 7A being engaged with, and deformed by, a column, in accordance with an embodiment;

FIG. 8A is a plan view of a collar, in accordance with an embodiment;

FIG. 8B is a perspective view of the collar of FIG. 8A;

FIG. 8C is a perspective view of the collar of FIG. 8A being engaged with, and deformed by, a column, in accordance with an embodiment;

FIG. 9A is a perspective view of an effector of a coupled to an actuator, in accordance with an embodiment;

FIG. 9B is a perspective exploded view of the effector of FIG. 9A;

FIG. 9C is a partial sectional view through the effector of FIG. 9A;

FIG. 10 is a schematic flow diagram of a target irradiation system, in accordance with an embodiment;

FIG. 11A is a plan view of a target irradiation system in an operational stage, in accordance with an embodiment;

FIG. 11B is a plan view of the target irradiation system in another operational stage, in accordance with an embodiment;

FIG. 11C is a plan view of the target irradiation system in yet another operational stage, in accordance with an embodiment;

FIG. 12 is a schematic flowchart of an example sequence of high-level operations of a target irradiation system;

FIG. 13 is a perspective of a target case, in accordance with an embodiment;

FIG. 14 is a perspective view of an irradiation chamber, in accordance with an embodiment;

FIG. 15 illustrates a block diagram of a processing device, in accordance with an embodiment;

FIG. 16 is a flow chart of an exemplary method of operating a target irradiation system; and

FIG. 17 is a flow chart of another exemplary method of operating a target irradiation system.

### DETAILED DESCRIPTION

The following disclosure relates to systems for irradiation of solid targets.

Solid irradiation targets are remotely manipulated to be placed in the irradiation position as well as for the transfer in and out of a transporting shuttle used to transport the solid irradiation target. The irradiation target is held in a target holder (or effector) that supplies the coolant and supports the target when placed in the irradiation chamber. The irradiation target is equipped with seals to seal the coolant on one side and to create a substantial vacuum seal on the other side when placed in the irradiation chamber.

Aspects disclosed herein may allow for self-aligning of irradiation targets on irradiation chambers, thereby allowing for the correction of any misalignment between the irradiation target and the mating parts during manipulation in and out the irradiation chamber. A collar serving as a flexing member between the actuator applying the force and the target holder is provided for such purposes. Rather than being rigidly coupled, the actuator tip may be allowed to slide on a ball or other spherical surface when pressing the irradiation target against a solid surface with freedom provided by the flexing of the flexible collar. Typical flexing freedom of two degrees in all direction may be possible and adequate for achieving full face contact with the mating surfaces of the irradiation target and the irradiation chamber as well as with the shuttle when transferred.

Aspects disclosed herein may allow for holding of the irradiation targets by effectors without the use of external clamps and specialized components. When cooling is not needed, cooling channels in the irradiation target are depressurized while in fluid communication with conduits in the holder. As a result, the irradiation targets are held on to the holder by suction, selectively and without the need for additional equipment.

Aspects of various embodiments are described in relation to the figures.

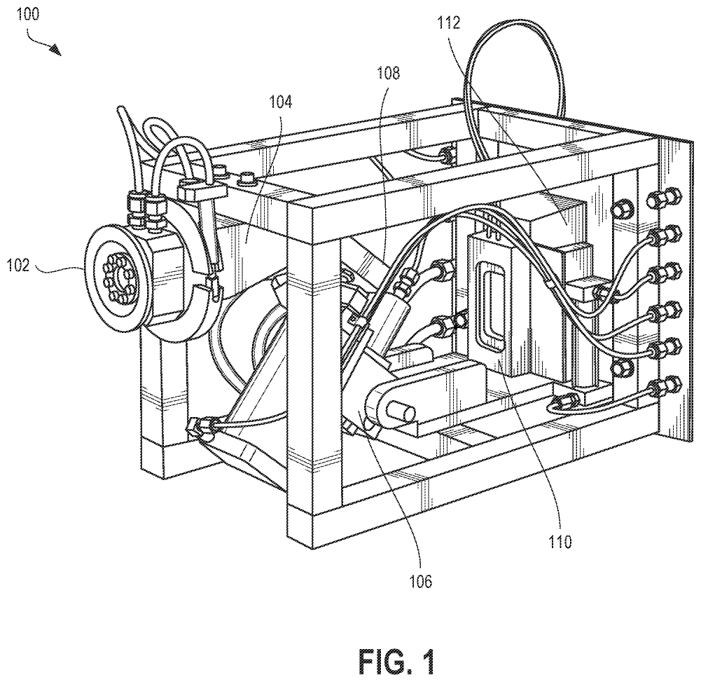

FIG. 1 is a perspective view of a target irradiation system 100, in accordance with an embodiment.

In various embodiments, the target irradiation system 100 may be particularly suitable for low current accelerator facilities, e.g. small cyclotron facilities, that may have low target or cyclotron vault penetrations.

As shown in FIG. 1, the target irradiation system 100 may generally comprise a metal cage, such as an aluminum cage, for containing various components. The target irradiation system 100 in FIG. 1 includes a collimator 102 that receives a beam from a cyclotron or similar device to collimate the beam. For example, in some embodiments, the collimator 102 may receive a circular beam of about a 16 mm diameter to form a 13 mm collimated beam. The collimation process may dissipate 10-15% of energy of the beam. As a result, the collimator 102 may be liquid cooled, e.g. water cooled, via a plurality of conduits connected to the collimator 102. In some embodiments, the collimator 102 may be a conical collimator.

In the embodiment of FIG. 1, the collimator 102 may be attached to an irradiation chamber 104 at a first end thereof. The other end of the irradiation chamber 104 is defined or formed by a solid irradiation target that is sealed against the irradiation chamber 104. In various embodiments, the irradiation target is attached or pressed on to the irradiation chamber 104 at an angle, e.g. it may be inclined at 14° to the beam and the irradiation target. The irradiation target may be clad with irradiated material on the front or inner face thereof. Cooling channels may be disposed on the back or outer face thereof to dissipate heat while maintaining the target face temperature at a desired level. The cooling channels may receive coolant for cooling and may be configured to return processed/heated coolant. In various embodiments, the temperature of the coolant may be monitored.

The irradiation target may be brought into position by a robotic manipulator 106 via an effector 108 that is coupled to the robotic manipulator 106. In various embodiments, the robotic manipulator 106 may comprise one or more pneumatic actuators. In some embodiments, the robotic manipulator 106 may comprise three pneumatic actuators. In some embodiments, the robotic manipulator 106 may comprise a linear actuator and a rotary actuator. Fresh (unused) irradiation targets may be pre-loaded in a detachable target case 112. In various embodiments, the target case snaps into place for convenient replacement and, in some embodiments, may hold up to 20 irradiation targets.

The robotic manipulator 106 may be configured to grab a fresh irradiation target from the target case 112, place it in the irradiation chamber 104, and insert it in a dissolution vessel 110 at the end of irradiation.

Advantageously, in the target irradiation system 100 of FIG. 1, processing of the irradiation target may partially or fully be conducted at or adjacent to the irradiation site. Once irradiation by of the irradiation target is completed, the robotic manipulator 106 may move the irradiated target to the dissolution vessel 110, where it is processed for subsequent liquid transport of the irradiated target material to the radiochemistry area (processing hot-cell). Such liquid transport may be achieved with small diameter tubes that may be relatively easy to handle and route. In various embodiments, used irradiated targets may be released at the end of dissolution dropped into a shielded container for storage until the radioactivity levels drop.

The effector 108 may be configured to hold or support the irradiation target thereon by suction while the robotic manipulator 106 is in motion. Such suction may be achieved by evacuating coolant from one or more coolant passages and depressurizing the same, as will be explained further herein.

The effector 108 may be configured to achieve a tight seal against irradiation chamber 104 by means of a self-aligning mechanism, as will be further explained further herein.

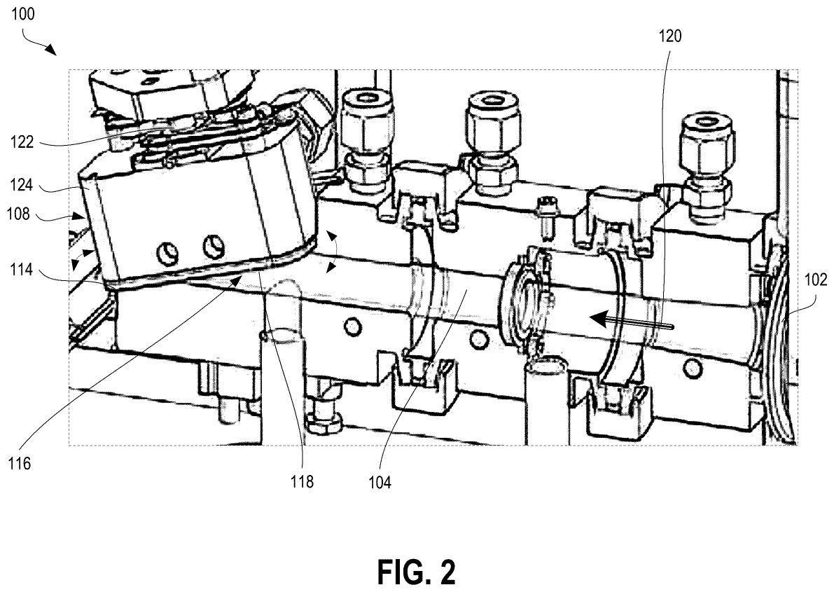

FIG. 2 is a partial sectional perspective view of an embodiment of the target irradiation system 100, showing a sectional through the irradiation chamber 104 as it engages with an effector 108.

As shown in FIG. 2, an irradiation target 114 engages with an opening 116 formed on the irradiation chamber 104. In particular, the irradiation chamber 104 receives an inner face 118 of the irradiation target 114 on the opening 116 in order to seal the irradiation chamber 104. In this position, a beam 120 passing through the irradiation chamber 104 via the collimator 102 irradiates the irradiation target 114. In particular, the beam 120 irradiates material that clads the inner face 118.

The irradiation chamber 104 may generally be sealed off during irradiation to prevent contamination, and to ensure the integrity and quality of the beam as it is absorbed by the irradiation target 114.

The effector 108 may press the irradiation target 114, and the inner face 118 thereof, against the irradiation chamber 104. In particular, the effector 108 may effect a sealing force on to the irradiation target 114 to sealingly engage the irradiation target 114 with the opening 116. The sealing force may be transmitted to the irradiation target 114 via a column 122 of the effector 108. In various embodiments, the column 122 passes through a holder 124 of the effector 108. In various embodiments, the holder 124 may be a monoblock, e.g. a block of substantially unitary construction that may be partially hollowed out.

It may be desirable to reduce or avoid misalignment between the irradiation target 114, particularly an inner face 118 thereof, and the opening 116 to ensure a good seal between the irradiation chamber 104 and the irradiation target 114. For example, angular misalignment between the inner face 118 and the opening 116, if not remedied, may lead to open gaps at the opening 116 or regions of weaking sealing, e.g. in the form of insufficiently compressed gasket between the irradiation target 114 and the irradiation chamber 104. In embodiments described herein, forces applied to the column 122 may serve to rotate and translate the platen 126, and hence the irradiation target 114, to facilitate alignment between the irradiation target 114 and the irradiation chamber 104. In FIG. 2, such example rotations of the effector 108 are illustrated using double-headed arrows. In particular, it is conceived that alignment may be achieved by rotation along at least one axis and translation along at least two axes, e.g. the axes defined in the plane of the collar.

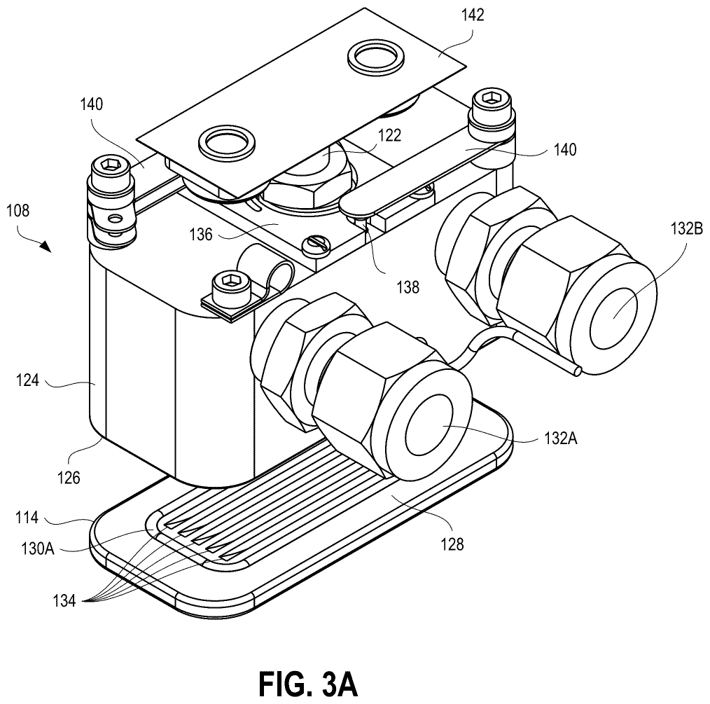

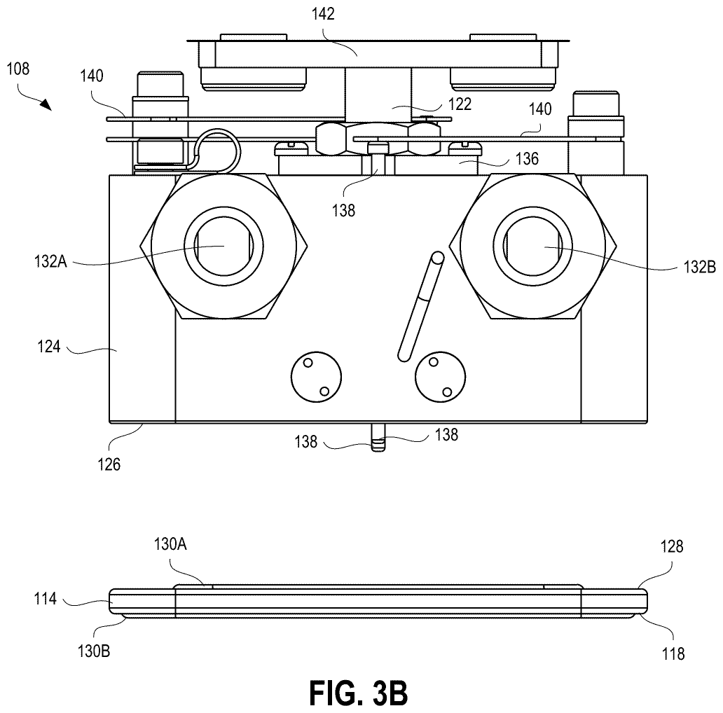

FIG. 3A is a perspective view of the effector 108 in position to engage with an irradiation target 114, in accordance with an embodiment.

FIG. 3B is rear elevation view of the effector 108 in position to engage with the irradiation target 114, in accordance with an embodiment.

In FIGS. 3A-3B, the robotic manipulator 106 or other means of handling the effector 108 are not shown for clarity.

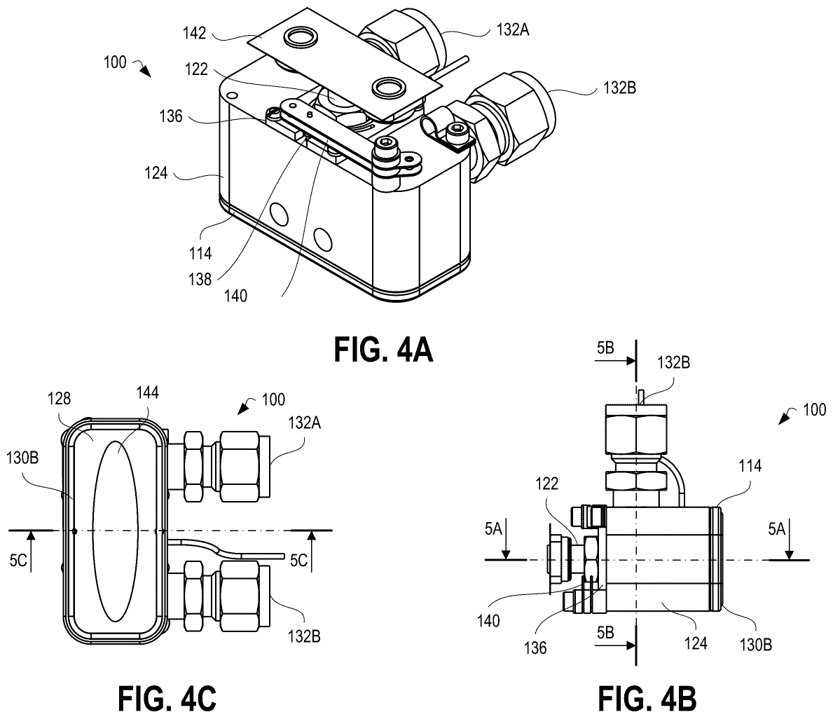

FIG. 4A is a perspective view of a target irradiation system 100 engaged with an irradiation target 114, in accordance with an embodiment.

FIG. 4B is a side elevation view of the target irradiation system 100 of FIG. 4A, in accordance with an embodiment.

FIG. 4C is bottom plan view of the target irradiation system 100 of FIG. 4A, in accordance with an embodiment.

Referring to FIGS. 3A-3B, 4A-4C, the effector 108 defines a platen 126 that is suitable for engaging with an outer face 128 of the irradiation target 114. In FIGS. 3A-3B, 4A-4C, the platen 126 is defined by an end of the holder 124, e.g. the platen 126 may be part of the holder 124. In various embodiments, the platen 126 may be a separate component from the holder 124 and may be integrally coupled to the holder 124. Once engaged with the outer face 128, the platen 126 may be employed to force or press the inner face 118 of the irradiation target 114 against the opening 116 of the irradiation chamber 104 to allow material 144 cladding the inner face 118 to be irradiated in the irradiation chamber 104.

The column 122 may be positioned to press onto the platen 126, via the holder 124, so as to transmit a sealing force that is received on the column 122.

The column 122 is also coupled to the platen 126 (and the holder 124) via a collar 136 that receives the column 122 to surround the column 122. The collar 136 may be attached to the platen 126, e.g. the collar 136 may be fastened to the holder 124 so as to be fastened to the platen 126, the collar 136 may be integrally coupled with the platen 126, and/or the collar 136 may be in unitary construction with the platen 126. In the embodiment of the effector 108 shown in FIG. 3A-3B, 4A-4C, the collar 136 is fastened to the holder 124 by means of four fasteners positioned at four separate corners of the collar 136. In various embodiments, the column 122 may be threadably engaged with the collar 136.

The collar 136 may be substantially elastically or resiliently deformable to deform when the column 122 is moved, e.g. tilted, rotated or translated, relative to the holder 124. At the same time, the collar 136 may be sufficiently rigid to support the column 122 while allowing movement thereof. The deformation of the collar 136 may generate additional stresses in the collar 136 that may be transmitted to the holder 124, and the platen 126. It is understood that forces transmitted to the platen 126 may then transmitted to the irradiation target 114 if the platen 126 is engaged or in contact with the irradiation target 114.

It is found that without the collar, or with an excessively (plastically) deformable collar, the column 122 does not self-align since the column 122 is allowed to freely move (e.g. rotate) without influencing positioning of the platen 126 relative to the irradiation chamber 104. With an excessively rigid collar, the column 122 remains fixed in place and the platen 126 is prevented from aligning relative to the irradiation chamber. For a sufficiently rigid but resiliently deformable collar, the platen 126 may move (rotate and/or translate) relative to the column 122 to allow alignment with the irradiation chamber 104. It is further found that such a resiliently deformable collar may not be strong enough to withstand pressing down of the platen 126 against the irradiation chamber 104, e.g. shattering of the collar 136 may be expected in some instances. As such, the relatively hard (rigid) orbicular surfaces provides an additional contact for transmission of forces from the column 122 to the irradiation target 114.

The irradiation target 114 may be adapted to couple to the irradiation chamber 104 and the effector 108 via sealing members. A gasket 130A may be disposed on the outer face 128 of the irradiation target 114 to seal the irradiation target 114 against the effector 108. A gasket 130B may be disposed on the inner face 118 to seal the irradiation target 114 against the irradiation chamber 104. The gaskets 130A, 130B may be disposed in corresponding grooves or seats formed in the respective outer face 128 and the inner face 118 of the irradiation target 114.

The outer face 128 of the irradiation target 114, configured to face the platen 126 and engage therewith, has formed thereon a plurality of cooling channels 134. The effector 108 may define conduits 132A, 132B that are in fluid communication with the cooling channels 134 when the platen 126 of the holder 124 is engaged with the outer face 128 of the irradiation target 114. The conduits 132A, 132B and the cooling channels 134 may be suitable for flowing coolant therein, e.g. water. As such, since the gasket 130A forms a seal between the holder 124 and the irradiation target 114, the conduits 132A, 132B and the cooling channels 134 may together form one or more coolant passages extending between the effector 108 and the irradiation target 114 for cooling the irradiation target 114 while the irradiation target 114 is being irradiated in the irradiation chamber 104. Such cooling may be particularly important, as the irradiation target 114 may experience elevated temperatures during irradiation.

As will be explained further later, the target irradiation system 100 may comprise one or more valves for selectively flowing fluids through the conduits 132A, 132B to selectively supply coolant or air, purge air, or draw air away from the conduits 132A, 132B (and hence the cooling channels 134).

The effector 108 may comprise plungers 138 attached to corresponding switches 140. First terminal ends of the plungers 138 may pass through apertures in the platen 126 and extend outwardly beyond the platen 126. When the irradiation target 114 is pressed against the platen 126, the plungers 138 are pressed into the holder 124 and into the switches 140 to actuate the switches 140. The switches 140 may be connected to circuitry such that their actuation provides a trigger to the circuitry, i.e. a signal indicative of engagement or disengagement of the platen 126 with the irradiation target 114. Advantageously, robust monitoring of the interaction of the effector 108 with the irradiation target 114 may be achieved without the use of relatively less reliable or more costly equipment, e.g. specialized contact sensors.

A connector 142 may be provided on the effector 108 to facilitate connection to a robotic manipulator or other similar device. The connector 142 may extend from a terminal end of the column 122. For example, the connector 142 may extend laterally from the terminal end of the column 122.

As referred to herein, engagement of the inner face 118 and outer face 128 with other components may include engagement via gaskets or sealing members.

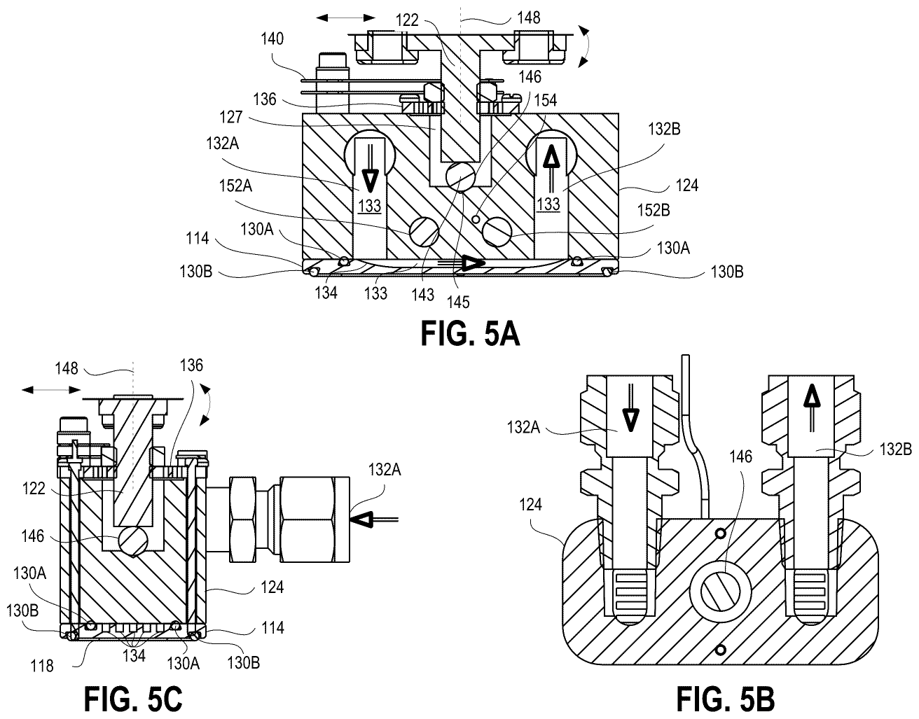

FIG. 5A is a cross-sectional view along the line 5A-5A in FIG. 4B.

FIG. 5B is a cross-sectional view along the line 5B-5B in FIG. 4B.

FIG. 5C is a cross-sectional view along the line 5C-5C in FIG. 4C.

Referring to FIGS. 5A-5C, the column 122 is configured to be received in a cavity 127 formed in the holder 124, which extends from an end of the holder 124 defined by the platen 126 to an opening of the cavity 127. The column 122 is configured to receive a sealing force to transmit the sealing force to the irradiation target so as to seal the platen 126 against the irradiation target 114. The column 122 is positioned to press onto the platen via an orbicular surface 146 to facilitate positioning of the column 122 relative to the platen 126. In various embodiments, the orbicular surface is spherical, partially spherical, convex, or other type of surface that allows the column 122 to remain in force communication or contact with the platen 126 as the column 122 is moved.

In FIGS. 5A-5C, the orbicular surface 146 is a substantially spherical surface of a sphere or a ball 143 that is seated in a groove 145 or seat formed in the holder 124. An internal (terminal) end of the column 122 is substantially flat and in contact with the ball so that as the column 122 is moved, the internal end remains in contact with the orbicular surface 146. Thus, application of a force onto the column 122 allows the force to be transmitted to the irradiation target 114, even as the column 122 is being repositioned. Such repositioning may involve rotation of the column 122 around its axis 148 or about axes orthogonal thereto and/or translation about two or more axes, as illustrated by double-headed arrows in FIGS. 5A-5C representing notional repositioning,

The collar 136 maybe coupled to or fastened to the opening of the cavity 127, distal from the platen 126, to allow the column 122 to be received in the cavity 127 via the collar 136. As the column 122 is rotated and/or translated, the collar 136 is resiliently deformed. For example, the collar 136 may be a fenestrated or slitted structure in a portion of the collar 136 surrounding the column 122 (or aperture of the collar 136 receiving the column 122) to encourage its deformation. Such resilient deformation, while allowing the sealing force to be transmitted on to the platen 126 via the orbicular surface 146 or not obstructing the same, may force the platen 126 against the irradiation target 114 in such a manner as to facilitate alignment, e.g. angular alignment, of the platen 126 and the outer face 128 of the irradiation target 114. Such alignment may facilitate sealing of the inner face 118 of the irradiation target 114 against the irradiation chamber 104. For example, in some situations, the platen 126 may be inclined 1-2° relative to the outer face 128, which may lead to poor sealing or gaps along the gasket. In this case, application of a sealing force through the column 122 may cause the column 122 to rotate as the platen 126 is pushed against the irradiation target 114. Such rotation of the column 122 may cause the resiliently deformed collar 136 to preferentially push down against the platen 126 to rotate the platen 126 on to the irradiation target 114.

Misalignment, including translational misalignment, between the irradiation target 114 and the irradiation chamber 104 may be similarly addressed. For instance, the collar 136 may be resiliently deformable so as to, while allowing the sealing force to be transmitted on to the platen 126 via the orbicular surface 146, force the platen 126 against the opening 116 of the irradiation chamber 104 via the irradiation target 114 to facilitate alignment of the platen 126 and the irradiation chamber 104 to seal the inner face 118 of the irradiation target 114 against the irradiation chamber 104.

Coolant passages 133 may be defined between the effector 108 and the irradiation target 114. Such coolant passages 133 extend between conduits 132A, 132B of the effector 108 to cooling channels 134 of the irradiation target 114. Coolant may be supplied to the coolant passages 133 to cool the irradiation target 114. Such flow through the coolant passages is notionally indicated by arrows with hollow arrowheads in FIGS. 5A-5C. As shown in FIGS. 5A-5B, the conduit 132A may be a supply conduit for coolant and conduit 132B may be a return conduit for coolant.

When cooling of the irradiation target 114 is not required, the coolant passages 133 may be evacuated of coolant. In such a state, depressurizing the coolant passages 133 may cause suction between the irradiation target 114 and the effector 108 so as to support the irradiation target 114 on the effector 108. Advantageously, the effector 108 may thereby be able to hold on to the irradiation target without the need for external clamps or other bulky equipment.

In various embodiments, heating elements 152A, 152B may be provided in the holder 124 proximal to the conduits 132A, 132B and/or the cooling channels 134. These heating elements may be operably connected to circuitry or a controller to control the temperature of the irradiation target 114, in combination with the coolant. For example, such control may include generating a control signal based on temperature measurements generated by a temperature sensor 154 (e.g. a thermocouple) positioned to sense the temperature of the irradiation target 114.

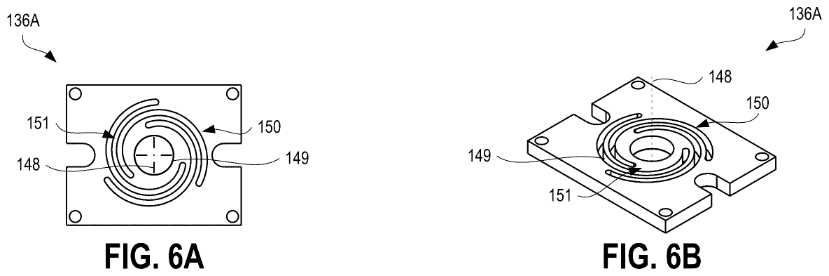

FIG. 6A is a plan view of a collar 136A, in accordance with an embodiment.

FIG. 6B is a perspective view of the collar 136A of FIG. 6A.

The collar 136A includes an opening or central aperture 149 extending around the axis 148 for receiving the column 122. The central aperture 149 may be adapted to receive and mate to the column 122.

The region around the central aperture 149 may be fenestrated (defining a fenestrated portion 151 surrounding the central aperture 149) or otherwise comprise openings which decrease rigidity of the collar 136A and allows its deformation. Such openings are configured so as to substantially isotropically reduce rigidity to allow similar deformation of the collar 136A and material response as the column 122 is tilted in various directions relative to the collar 136A.

In particular, a plurality of arcuate slots 150 may be distributed around the axis 148. For example, three arcuate slots may extend around the axis 148 and may be spirally shaped, i.e. spiral inwards towards the aperture 149. The plurality of arcuate slots 150 may be interleaved with each other in a spiral manner.

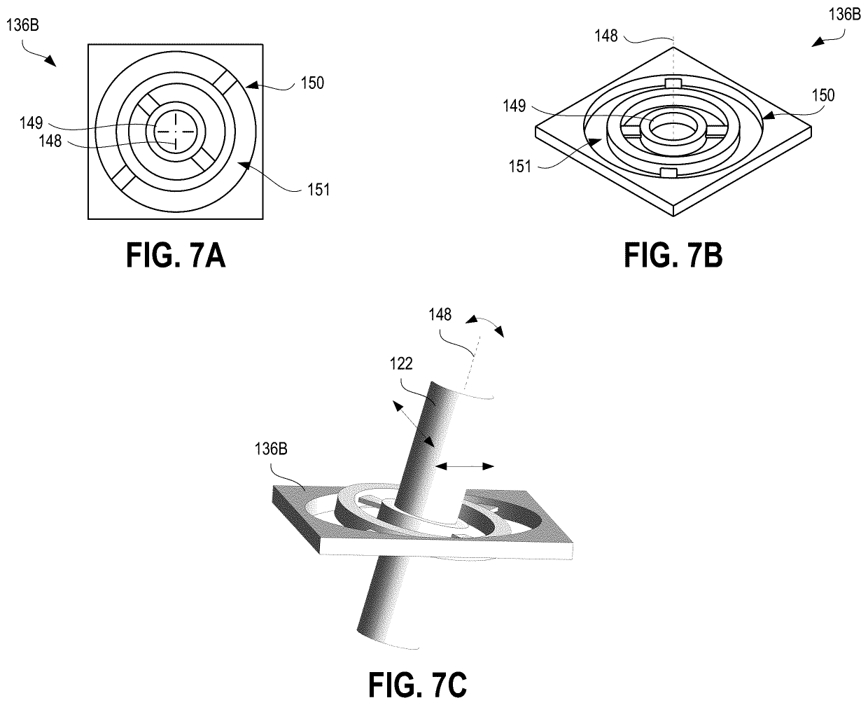

FIG. 7A is a plan view of a collar 136B, in accordance with an embodiment.

FIG. 7B is a perspective view of the collar 136B of FIG. 7A.

FIG. 7C is a perspective view of the collar 136B of FIG. 7A being engaged with, and deformed by, a column 122, in accordance with an embodiment.

The collar 136B may be defined by two (partly) circular or arcuate slots 150 defined between two an outer end of the collar 136B, an outer circular strip supportably connected to the outer end by at least two tabs extending therebetween, and an inner circular strip defining the aperture 149 and supportably connected to the outer circular strip by at least two tabs extending therebetween. The plurality of slots 150 here are radially spaced apart from each other.

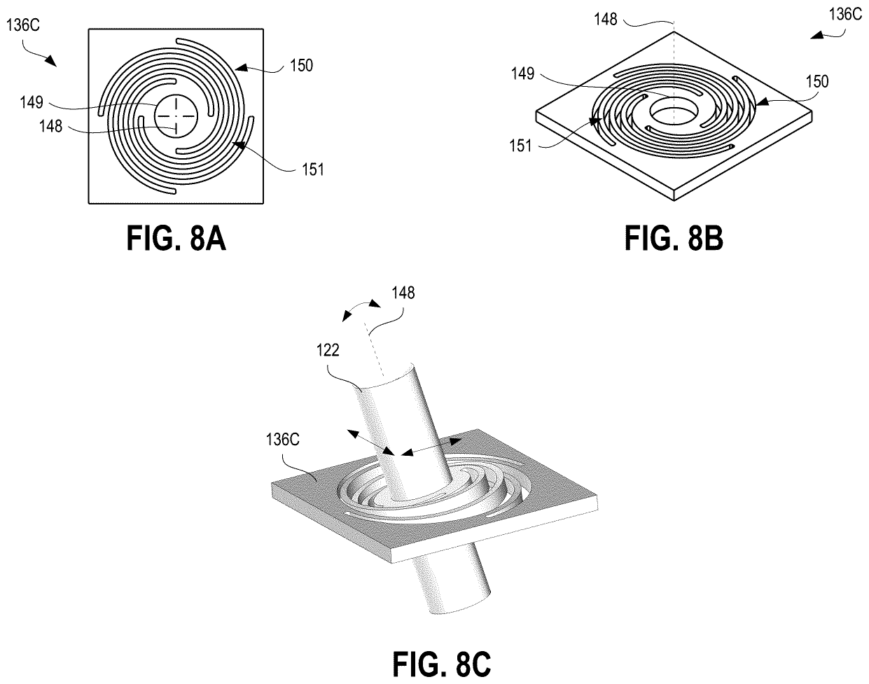

FIG. 8A is a plan view of a collar 136C, in accordance with an embodiment.

FIG. 8B is a perspective view of the collar 136C of FIG. 8A.

FIG. 8C is a perspective view of the collar 136C of FIG. 8A being engaged with, and deformed by, a column 122, in accordance with an embodiment.

The collar 136C in FIGS. 8A-8C may be similar in some respects to the collar 136A in FIGS. 136A-136B. In contrast to the collar 136A, the collar 136C may comprise four arcuate slots 150. These four arcuate slots 150 extend helically or spirally from an outer end of the collar 136C towards the aperture 149 at the center of the collar 136C, as shown.

The collars 136A-136C shown in FIGS. 6A-6B, 7A-7C, 8A-8C may be monolithically constructed, e.g. made substantially of a single material, e.g. aluminum. The material forming the collar 136 may generally be identical to the material forming the holder 124 or may be identical in its elasticity, yield stress, and other strength related characteristics. In various embodiments, the material(s) forming the column 122 and the orbicular surface 146 may substantially harder than the collar or holder material, e.g. the material may include ceramic or stainless steel.

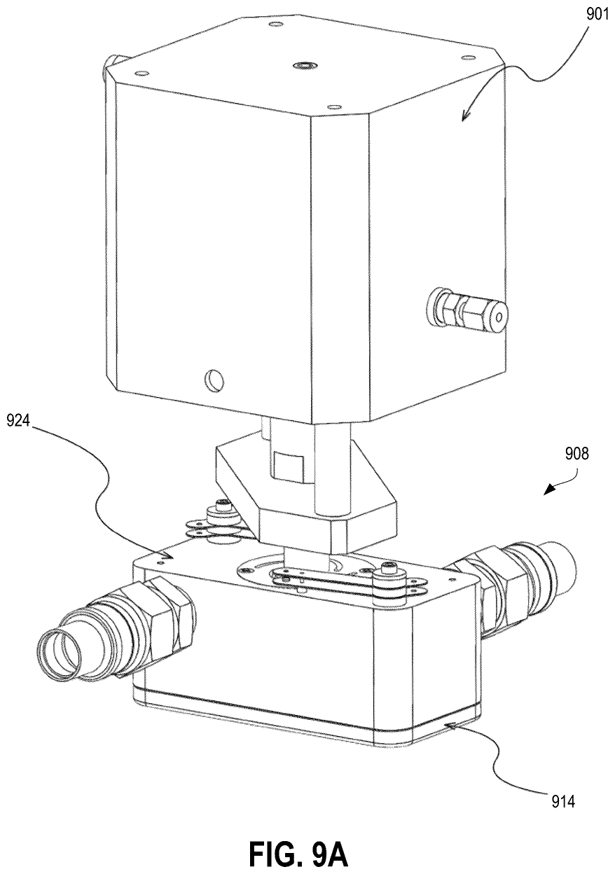

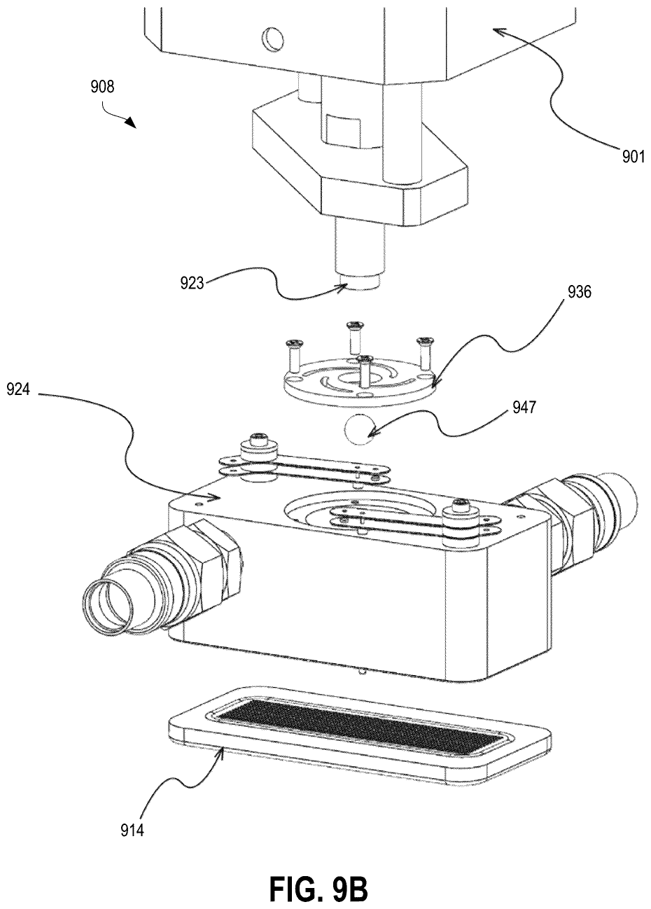

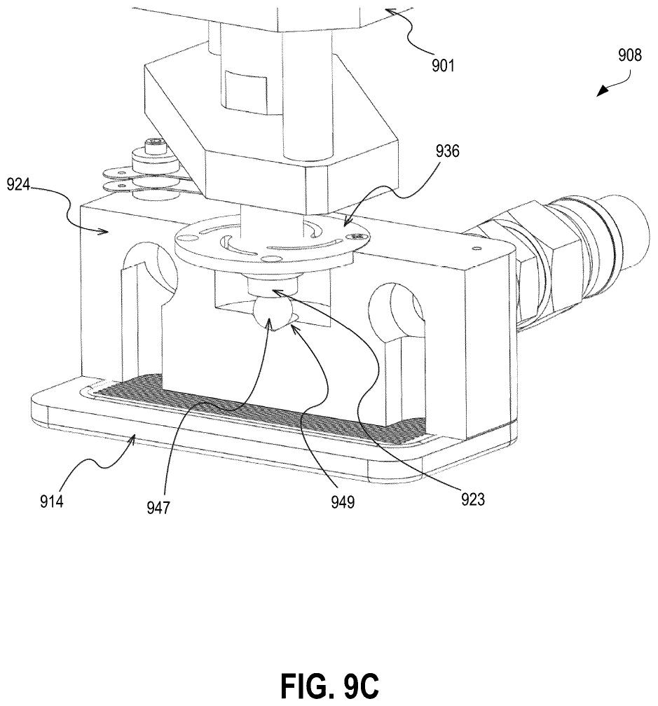

FIG. 9A is a perspective view of an effector 908 of a coupled to an actuator 901, in accordance with an embodiment.

FIG. 9B is a perspective exploded view of the effector 908 of FIG. 9A.

FIG. 9C is a partial sectional view through the effector 908 of FIG. 9A.

The effector 908 in FIGS. 9A-9C may be substantially similar to the effector 108 in FIGS. 3A-3B. The effector 908 is configured to receive forcing from the actuator 901. A tip 923 made of hard material (e.g. steel or ceramic) transmits this force to a ball 947 of hard material (e.g. steel or ceramic) that is substantially fixedly (non-movingly, including non-rotatingly and non-translatably) seated in a ball seat 949. The force is then transmitted from the ball 947 to a holder 924. When the holder 924 is engaged with an irradiation target 914, the force is transmitted thereto. A collar 936 or flexing material is fastened to the holder 924. The collar 936 may be circular and may comprise a plurality of arc-shaped slots to allow deformation of the collar 936 in all directions. The collar 936 may be constructed of spring material, such as spring steel or similar material.

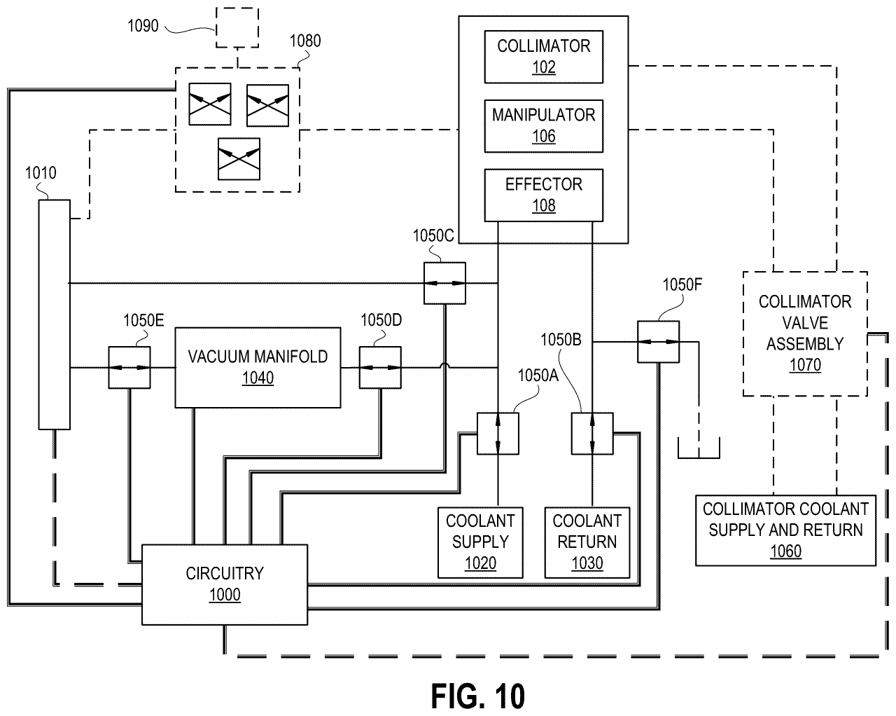

FIG. 10 is a schematic flow diagram of the target irradiation system 100, in accordance with an embodiment. In FIG. 10, communication, signal, and/or power lines are indicated by thick arrows.

As shown in FIG. 10, the target irradiation system 100 may include a plurality of valves 1050A, 1050B, 1050C, 1050D, 1050E, 1050F for selectively flowing fluids through the conduits 132A, 132B and the coolant passages 133.

The irradiation target 114 may be kept cool by coolant supplied from a coolant supply 1020 for absorbing heat from the irradiation target 114. The coolant may then return to be cooled via a coolant return 1030. In various embodiments, the coolant may be water.

The collimator 102 may be similarly kept cool by supply of coolant from, and returned to, a collimator coolant supply and return 1060. Coolant supply and return from the collimator 102 may be controlled by a collimator valve assembly 1070.

Pressurized air may be supplied to the rest of the target irradiation system 100 from a compressed air supply 1010, e.g. the compressed air supply 1010 may be a generator.

The target irradiation system 100 may include a vacuum manifold 1040 for generating a vacuum or causing suction. In some embodiments, the vacuum manifold 1040 may include a fluid eductor configured to receive pressurized air from the compressed air supply 1010 to generate a pressure gradient for drawing fluids out of the coolant passages 133 and depressurizing the coolant passages 133. Such a fluid eductor may also be referred to as a vacuum ejector. It is understood that other types of vacuum pumps may be used.

Compressed air from the compressed air supply 1010 may further be supplied to the manipulator 106. For example, one or more actuators of the manipulator 106 may be pneumatically operated. A valve assembly 1080, connected to a vent 1090, may serve to control the supply of compressed air to the manipulator 106 and/or components of the target irradiation system 100 other than the effector 108.

The valves 1050A-1050F, the vacuum manifold 1040, the valve assembly 1080, and/or the collimator valve assembly 1070 may be operably coupled to circuitry 1000. For example, circuitry 1000 may include programmable logic controller(s) (PLCs). The circuitry 1000 may generate signals to operate the valves 1050A-1050F, components of the vacuum manifold 1040 (such as vacuum pumps), and valves of the valve assembly 1080 and the collimator valve assembly 1070. In various embodiments, the circuitry 1000 may be configured to control supply of fluids (coolant and/or compressed air) to the collimator 102, manipulator 106, and/or the effector 108 in a feedforward manner or in a feedback manner. For example, one or more flow sensors may be provided to generate data indicative of flow conditions, such data being transmitted to the circuitry 1000, which may generate signals to operate components based on this data. For example, binary signals, such as those indicating pressing of a platen 126 against an irradiation target 114 may be used to determine a control schedule or configuration by the circuitry 1000. The circuitry 1000 may be configured to execute one or more methods described herein or cause execution of steps of methods described herein.

In a first operational configuration, valves 1050A-1050B are opened, and valves 1050C-1050F are closed. In this configuration, coolant is supplied to the effector 108 for cooling the irradiation target 114 and suitably drawn away to maintain cooling efficacy. In this configuration, flow lines leading to the valve 1050F may be flooded with coolant.

In a second operational configuration, valves 1050A-1050B are closed to stop the supply of coolant. At the same time, valve 1050C is open to supply compressed air to purge the coolant passages 133 (purge air) and valve 1050F is open to allow draining of coolant from the coolant passages 133. Valves 1050D, 1050E remain closed in this configuration. In this configuration, flow lines leading to the effector 108 from the coolant supply 1020 may also be effectively purged.

In a third operational configuration, valves 1050A-1050C are closed to stop the supply of coolant and compressed air. Additionally, valve 1050F is closed to stop flow communication with the coolant drain. At the same time, valve 1050E is opened to supply compressed/pressurized air to the vacuum manifold 1040 to operate the vacuum pump and valve 1050D is opened to depressurize the coolant passages 133 and establish suction. In this configuration, flow lines leading to the valves 1050A-1050B and valve 1050F may each be individually depressurized due to their flow communication with the coolant passages 133.

It is understood that additional operational configurations may be achievable. FIG. 10 represents a simplified view of valve assemblies. It is understood that additional components, e.g. additional valves, flow control devices, switches (including limit switches), sensors, and/or triggers may be provided. For example, temperature sensors may be provided to measure the temperature of the coolant, and flow control devices may be provided to vary the supply of the coolant to ensure efficacious heat rejection.

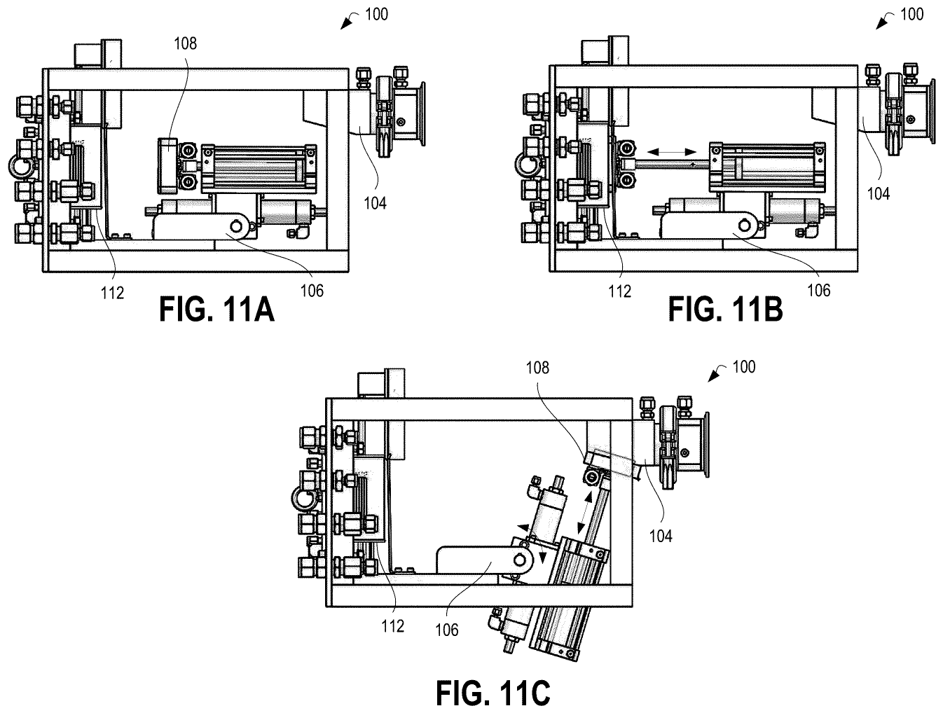

FIG. 11A is a plan view of the target irradiation system 100 in an operational stage, in accordance with an embodiment.

In this operational stage, the robotic manipulator 106 is positioned in its home position.

FIG. 11B is a plan view of the target irradiation system 100 in another operational stage, in accordance with an embodiment.

In this operational stage, which may occur after the operational stage shown in FIG. 11A, the robotic manipulator 106 grabs an irradiation target 114 from the target case 112. This is achieved by a linear actuator extending the manipulator 106 to allow the effector 108 to lift the irradiation target 114 off the target case 112 by suction.

FIG. 11C is a plan view of the target irradiation system 100 in yet another operational stage, in accordance with an embodiment.

In this operational stage, which may occur after the operational stage shown in FIG. 11B, the robotic manipulator 106 rotates the effector 108 and extends itself to press the irradiation target 114 on to the irradiation chamber 104.

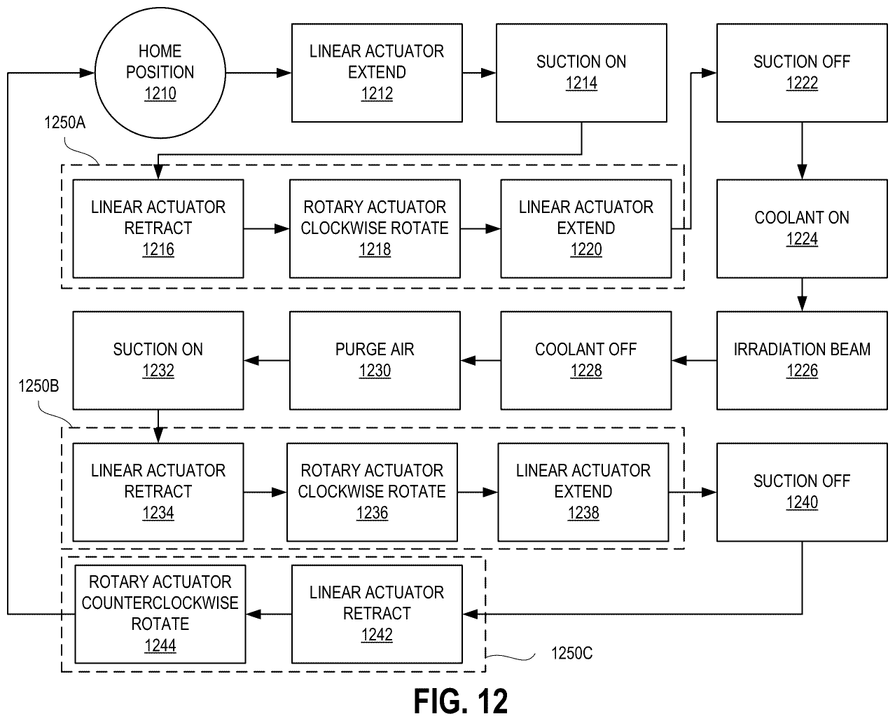

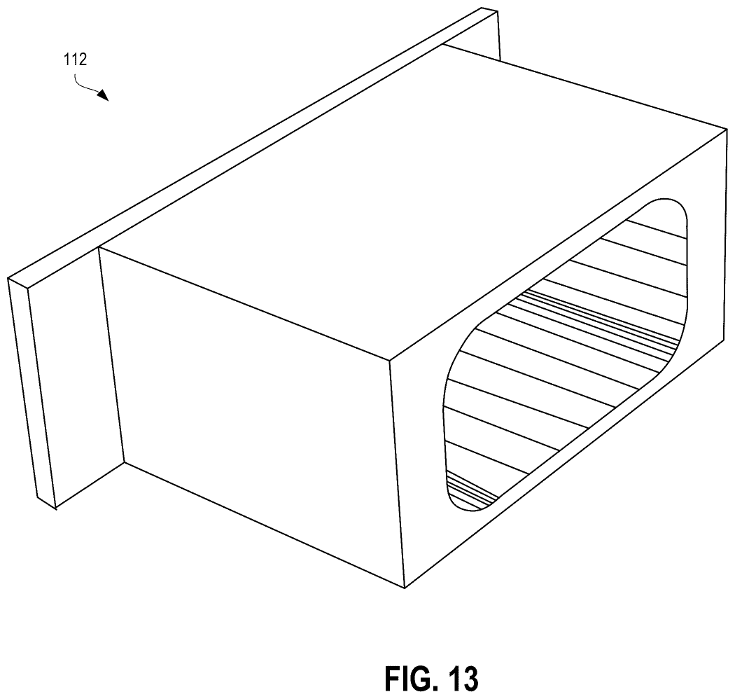

FIG. 12 is a schematic flowchart of an example sequence of high-level operations of the target irradiation system 100.

Referring to the sequence of operations in FIG. 12, the target irradiation system 100 and its robotic manipulator 106 start at the home position (step 1210). Thereafter, a linear actuator extends the manipulator 106 to position the effector 108 on an irradiation target 114, e.g. on the target case 112 (step 1212). Suction of the effector 108 by depressurization of the coolant passages 133 is turned on to support or hold the irradiation target 114 on to the effector 108 (step 1214).

In the next sequence of steps (sequence 1250A), the irradiation target 114 on the effector 108 is repositioned on to the irradiation chamber 104 and pressed thereonto to seal the irradiation chamber 104. The sequence 1250A includes, while suction is on and the irradiation target 114 is supported on the effector 108, retracting the manipulator 106 by the linear actuator (step 1216), rotating the manipulator 106 in the clockwise direction by a rotary actuator (step 1218), and extending the manipulator 106 by the linear actuator (step 1220).

Once the irradiation target 114 is positioned and sealingly pressed onto to the irradiation chamber 104, suction is turned off (step 1222), coolant supply to the irradiation target is turned on (step 1224), and then the irradiation beam 120 is supplied to irradiate the irradiation target 114 (step 1226). Once the material 144 is irradiated to a predetermined level, e.g. as inferred by a duration of irradiation or by sensing properties indicative of the irradiation stage, the irradiation beam is turned off (step 1226). Then the coolant supply is turned off and the remaining coolant supply is drawn out (step 1228), and purge air is supplied to fully purge the coolant passages (step 1230). Suction of the effector 108 by depressurization of the coolant passages 133 is then turned on to support or hold the irradiation target 114 on to the effector 108 (step 1232).

In the next sequence 1250B of steps, the irradiation target 114 is repositioned to the dissolution vessel 110 or to a place for removal from the target irradiation system 100 to a processing area. The sequence 1250B includes, while suction is on and the irradiation target 114 is supported on the effector 108, retracting the manipulator 106 by the linear actuator (step 1234), rotating the manipulator 106 in the clockwise direction by the rotary actuator (step 1236), and extending the manipulator 106 by the linear actuator (step 1238).

Suction is then turned off to release the irradiation target (step 1240) and the target irradiation system 100 is returned to its home position by another sequence 1250C of steps. The sequence 1250C includes, while suction is off, rotating the manipulator 106 in the counterclockwise direction by the rotary actuator (step 1244), and retracting the manipulator 106 by the linear actuator (step 1242) to return to the home position to repeat the steps.

The schematic in FIG. 12 is illustrative only. It is understood that each of the steps may include several sub-steps. The particular steps in the sequences 1250A-C may vary depending on the degrees of freedom of the robotic manipulator 106 and the types of actuators available thereto. Additional steps or triggers may intervene between the steps shown in FIG. 12. For example, a trigger may be based on time-duration, or a signal generated by the switch 140 when the irradiation target is pressed against the platen 126.

FIG. 13 is a perspective of a target case 112, in accordance with an embodiment.

The target case 112 defines a body that has a cross-section dimensioned based on the irradiation target 114 and elongated in a lateral direction there to receive and house a stacked plurality of irradiation targets 114, which may then be released (one at a time) from an opening of the target case 112.

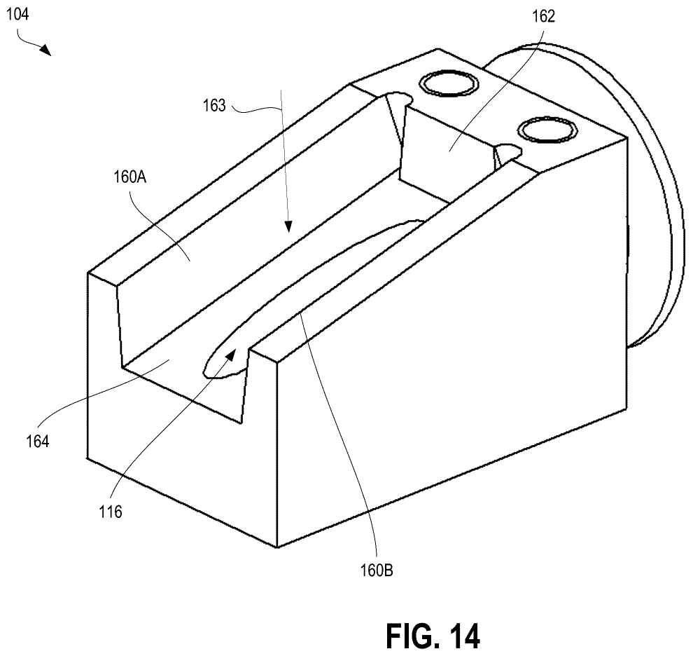

FIG. 14 is a perspective view of an irradiation chamber 104, in accordance with an embodiment.

In FIG. 14, the irradiation chamber 104 is configured to guide and push the irradiation target 114 into alignment with the opening 116 of the irradiation chamber 104 so as to facilitate achieving full face contact and sealing. The irradiation chamber 104 here may define a receiving face 164 that is suitable for abutting or receiving the inner face 118 of the irradiation target 114. When so received, the material 144 cladding the inner face 118 is received in the opening 116 so as to be irradiated. The receiving face 164 may be externally bounded on two opposite sides by side walls 160A, 160B. The receiving face 164 may be bounded on a third side by a front wall 162.

Each of the side walls 160A, 160B and the front wall 162 may extend outwardly from the receiving face 164 and is angled outwardly, or splayed away, from the receiving face 164. As such, one or more of the side walls 160A, 160B and the front wall 162 may receive an irradiation target 114 thereon, as long as the irradiation target 114 approaches the receiving face 164 in a misaligned manner, so as to push the irradiation target 114 away to thereby facilitate alignment of the irradiation target 114 with the receiving face 164. In particular, reaction forces (in reaction to the force of the column 122 pushing against the irradiation chamber 104 via the platen 126 and the irradiation target 114) applied on to the irradiation target 114 by the side walls 160A, 160B and the front wall 162 may deform the collar 136 so as to allow alignment of the irradiation target 114 without commensurate movement of the column 122. The general direction 163 of approach of the irradiation target 114 on to the receiving face 164 is indicated in FIG. 14.

In the embodiment of FIG. 14, the receiving face 164 is not bounded at an end thereof opposite to the front wall 162. It is understood that, in some embodiments, a fourth (outwardly splayed) wall may be provided opposite to the front wall 162 so as to help locate the irradiation target 114 onto the opening 116 in an aligned manner to achieve full face sealing.

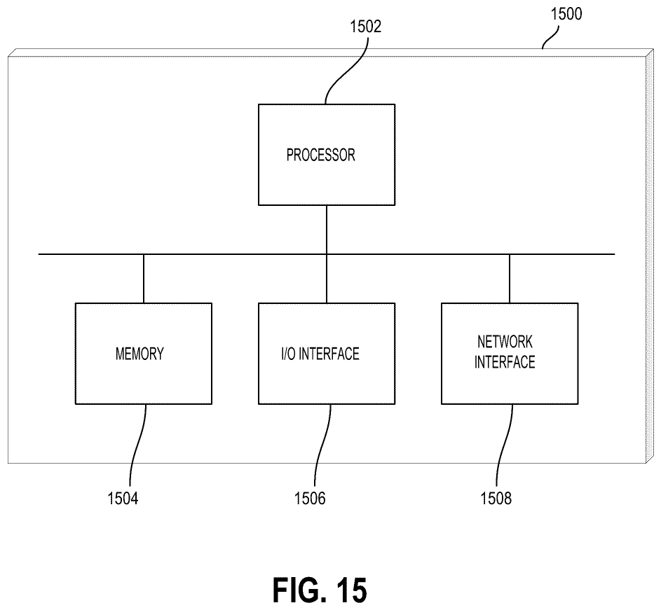

FIG. 15 illustrates a block diagram of a processing device 1500 or computing device, in accordance with an embodiment.

As an example, the circuitry 1000 of FIG. 10 may be implemented using the example device 1500 of FIG. 15. In various embodiments, the circuitry 1000 may include non-transitory machine-readable memory configured to execute one or more methods and/or cause the steps of one or more methods, including those described herein.

The computing device 1500 includes at least one processor 1502, memory 1504, at least one I/O interface 1506, and at least one network communication interface 1508.

The processor 1502 may be a microprocessor or microcontroller, a digital signal processing (DSP) processor, an integrated circuit, a field programmable gate array (FPGA), a reconfigurable processor, a programmable read-only memory (PROM), or combinations thereof.

The memory 1504 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

The I/O interface 1506 may enable the computing device 1500 to interconnect with one or more input devices, such as a keyboard, mouse, camera, touch screen and a microphone, or with one or more output devices such as a display screen and a speaker.

In various embodiments, the networking interface 1508 may be configured to receive and transmit data sets to a target data storage or data structures. The target data storage or data structure may, in some embodiments, reside on a computing device or system such as a mobile device.

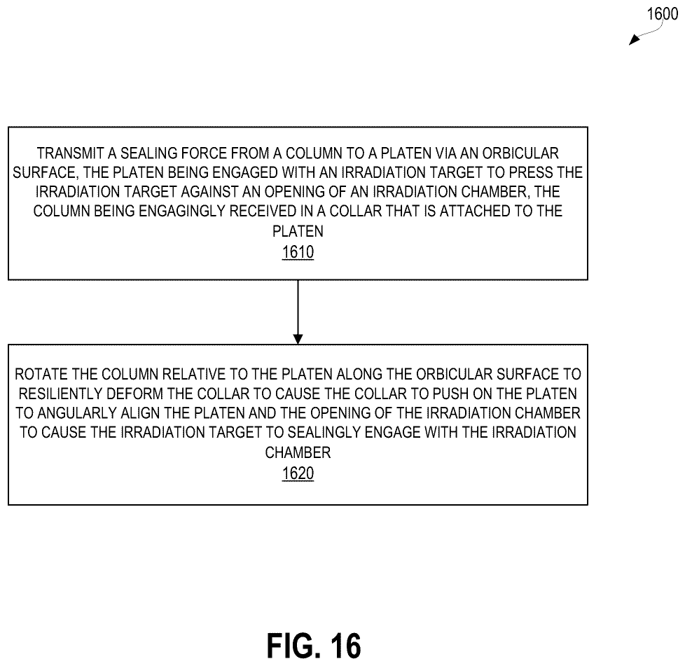

FIG. 16 is a flow chart of an exemplary method 1600 of operating a target irradiation system.

Step 1610 of the method 1600 includes transmitting a sealing force from a column to a platen via an orbicular surface, the platen being engaged with an irradiation target to press the irradiation target against an opening of an irradiation chamber, the column being engagingly received in a collar that is attached to the platen.

Step 1620 of the method 1600 includes, while transmitting the sealing force from the column to the platen via the orbicular surface, moving (e.g. rotating and/or translating) the column relative to the platen along the orbicular surface to resiliently deform the collar to cause the collar to push on the platen to align the platen and the opening of the irradiation chamber to cause the irradiation target to sealingly engage with the irradiation chamber.

In some embodiments of the method 1600, the collar defines an aperture surrounded by at least three arcuate slots extending around the aperture to allow the collar to deform to allow the column to move (e.g. rotate and/or translate) while forcing the platen against the irradiation target to facilitate alignment of the platen and the irradiation target.

In some embodiments of the method 1600, the platen is defined by an end of a holder, the holder extending between the end and an opening of a cavity formed in the holder, the cavity extending in the holder towards the platen, the collar being fastened to the opening of the cavity to allow the column to be received into the cavity via the collar, the cavity defining a groove for seating a ball defining the orbicular surface such that the column is allowed to push against the ball when disposed in the cavity.

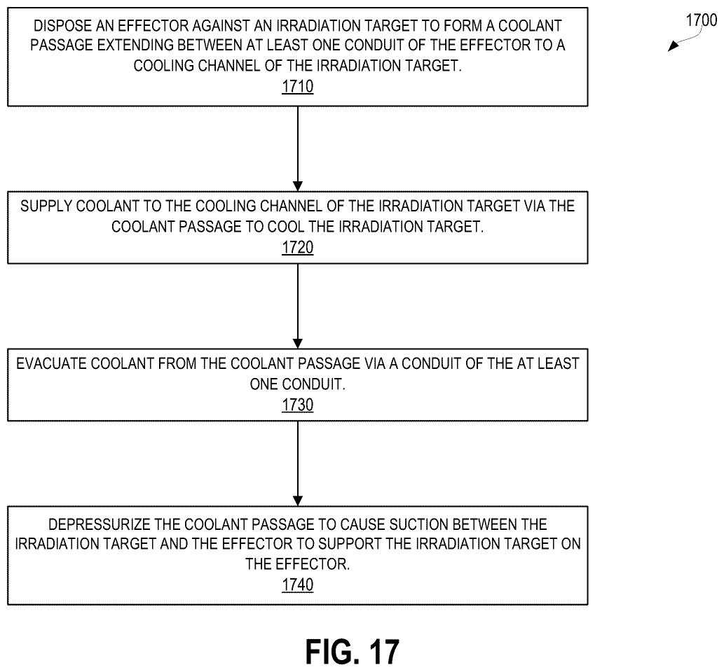

FIG. 17 is a flow chart of another exemplary method 1700 of operating a target irradiation system.

Step 1710 of the method 1700 includes disposing an effector against an irradiation target to form a coolant passage extending between at least one conduit of the effector to a cooling channel of the irradiation target.

Step 1720 of the method 1700 includes supplying coolant to the cooling channel of the irradiation target via the coolant passage to cool the irradiation target.

Step 1730 of the method 1700 includes evacuating coolant from the coolant passage via a conduit of the at least one conduit.

Step 1740 of the method 1700 includes depressurizing the coolant passage to cause suction between the irradiation target and the effector to support the irradiation target on the effector.

In some embodiments of the method 1700, the conduit is a first conduit, the coolant passage extending between the first conduit and a second conduit of the at least one conduit via the cooling channel, the first conduit drawing coolant out of the effector and the second conduit supplying coolant into the effector.

In some embodiments of the method 1700, evacuating coolant from the coolant passage via the conduit of the at least one conduit includes supplying pressurized gas to the coolant passage via the second conduit to purge coolant from the coolant passage via the first conduit.

In some embodiments of the method 1700, supplying coolant to the cooling channel of the irradiation target via the coolant passage to cool the irradiation target includes actuating one or more valves to draw coolant away from the coolant passage via the first conduit and to supply coolant to the coolant passage via the second conduit based on a signal generated by a switch operated by pressing of the effector against the irradiation target.

In some embodiments of the method 1700, depressurizing the coolant passage to cause suction between the irradiation target and the effector to support the irradiation target on the effector includes supplying pressurized gas to an ejector in fluid communication with the coolant passage to cause suction flow from the coolant passage to the ejector.

Some embodiments of the method 1700 further comprise disposing the effector against the irradiation chamber while the coolant passage is depressurized.

Some embodiments of the method 1700 further comprise pressing the effector against the irradiation chamber to seal the irradiation target against the opening,

In some embodiments of the method 1700, supplying coolant to the cooling channel of the irradiation target via the coolant passage to cool the irradiation target includes pressurizing the coolant passage.

In some embodiments of the method 1700, the effector against the irradiation chamber to seal the irradiation target against the opening includes transmitting a sealing force from a column of the effector to a platen of the effector via an orbicular surface, the platen being engaged with the irradiation target to press the irradiation target against the opening, the column being engagingly received in a collar that is attached to the platen; and while transmitting the sealing force from the column to the platen via the orbicular surface, moving the column relative to the platen along the orbicular surface to resiliently deform the collar to cause the collar to push on the platen to align the platen and the opening of the irradiation chamber to cause the irradiation target to sealingly engage with the irradiation chamber.

In some embodiments of the method 1700, the collar defines an aperture surrounded by at least three arcuate slots extending around the aperture to allow the collar to deform to allow the column to move while forcing the platen against the irradiation target to facilitate alignment of the platen and the irradiation target.

In some embodiments of the method 1700, the platen is defined by an end of a holder, the holder extending between the end and an opening of a cavity formed in the holder, the cavity extending in the holder towards the platen, the collar being fastened to the opening of the cavity to allow the column to be received into the cavity via the collar, the cavity defining a groove for seating a ball defining the orbicular surface such that the column is allowed to push against the ball when disposed in the cavity.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, multiple or no robotic manipulators may be utilized (for instance, where the effector is operated by hand or a mechanical aid), the orbicular surface may be a protrusion extending from the platen or holder or may be formed directly on the column 122, and/or irradiation target systems may be conceived without built-in collimeters. Yet further modifications could be implemented by a person of ordinary skill in the art in view of the present disclosure, which modifications would be within the scope of the present technology. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

1. An effector of a target irradiation system, the effector operable to apply a sealing force on to an irradiation target, the effector comprising:
a platen operable to press against the irradiation target;
a column receiving the sealing force and being positioned to press onto the platen, via an orbicular surface to facilitate positioning of the column relative to the platen, to transmit the sealing force on to the irradiation target; and
a collar receiving the column to surround the column, the collar attached to the column and the platen and being resiliently deformable so as to, while allowing the sealing force to be transmitted on to the platen via the orbicular surface, force the platen against the irradiation target to facilitate alignment of the platen and the irradiation target.

2. The effector of claim 1, wherein the collar defines an aperture surrounded by a plurality of arcuate slots extending around the aperture to allow the collar to deform to allow the column to move while forcing the platen against the irradiation target to facilitate alignment of the platen and the irradiation target.

3. The effector of claim 2, wherein the plurality of arcuate slots includes at least three arcuate slots interleaved with each other and extending spirally towards the aperture.

4. The effector of claim 1, wherein the platen is defined by an end of a holder, the holder extending between the end and an opening of a cavity formed in the holder, the cavity extending in the holder towards the platen, the collar being fastened to the opening of the cavity to allow the column to be received into the cavity via the collar.

5. The effector of claim 4, wherein the cavity defines a groove seating a ball defining the orbicular surface such that the column is allowed to push against the ball when disposed in the cavity.

6. A target irradiation system, comprising:
an irradiation chamber defining an opening configured to receive an inner face of an irradiation target to seal the irradiation chamber and allow a beam to irradiate the irradiation target; and
an effector operable to effect a sealing force on to the irradiation target to sealingly engage the irradiation target with the opening of the irradiation chamber, the effector including
a platen engaging with an outer face of the irradiation target to press the inner face of the irradiation target against the opening of the irradiation chamber, the inner face and the outer face of the irradiation target being opposite to each other,
a column receiving the sealing force and being positioned to press onto the platen, via an orbicular surface to facilitate positioning of the column relative to the platen, to transmit the sealing force on to the irradiation target, and
a collar receiving the column to surround the column, the collar attached to the column and the platen and being resiliently deformable so as to, while allowing the sealing force to be transmitted on to the platen via the orbicular surface, force the platen against the opening of the irradiation chamber via the irradiation target to facilitate alignment of the platen and the irradiation chamber to seal the inner face of the irradiation target against the irradiation chamber.

7. The target irradiation system of claim 6, wherein the collar defines an aperture surrounded by a fenestrated portion adapted to deform to allow the column to move while forcing the platen against the irradiation target to facilitate alignment of the platen and the outer face of the irradiation target.

8. The target irradiation system of claim 7, wherein the fenestrated portion includes a plurality of arcuate slots that at least partially surround the aperture and are radially spaced apart from each other.

9. The target irradiation system of claim 7, wherein the fenestrated portion includes at least three arcuate slots interleaved with each other and extending spirally towards the aperture.

10. The target irradiation system of claim 6, wherein the orbicular surface is a spherical surface of a ball seated in a groove, the ball being in contact with a substantially flat end of the column.

11. The target irradiation system of claim 6, wherein the platen is defined by an end of a holder, the holder extending between the end and an opening of a cavity formed in the holder, the cavity extending in the holder towards the platen, the collar being fastened to the opening of the cavity to allow the column to be received into the cavity via the collar.

12. The target irradiation system of claim 11, wherein the cavity defines a groove seating a ball defining the orbicular surface such that the column is allowed to push against the ball when disposed in the cavity.

13. The target irradiation system of claim 6, further comprising a robotic manipulator attached to the effector and configured to press the column to press the irradiation target.

14. The target irradiation system of claim 13, further comprising a target case housing a stacked plurality of irradiation targets, the robotic manipulator suitable to position the effector to engage with the stacked plurality of irradiation targets via an opening of the target case to retrieve the irradiation target.

15. The target irradiation system of claim 13, further comprising a dissolution vessel configured to process the irradiation target after irradiation, the robotic manipulator configured to insert the irradiation target into the dissolution vessel via the effector after irradiation of the irradiation target.

16. The target irradiation system of claim 6, wherein the effector is configured to engage with the irradiation target to cool the irradiation target while the irradiation target is being irradiated in the irradiation chamber, the effector defining at least one conduit fluidly communicating with at least one cooling channel of the irradiation target to form at least one coolant passage extending between the effector and the irradiation target.

17. The target irradiation system of claim 16, wherein the effector is configured to hold the irradiation target by suction of the irradiation target via the at least one coolant passage.

18. The target irradiation system of claim, wherein the irradiation chamber defines a plurality of walls extending outwardly from the opening, each of the plurality of walls being outwardly splayed away from the opening so as to push the irradiation target into alignment with the opening of the irradiation chamber.

19. A method of operating a target irradiation system, comprising:
transmitting a sealing force from a column to a platen via an orbicular surface, the platen being engaged with an irradiation target to press the irradiation target against an opening of an irradiation chamber, the column being engagingly received in a collar that is attached to the platen; and
while transmitting the sealing force from the column to the platen via the orbicular surface, moving the column relative to the platen along the orbicular surface to resiliently deform the collar to cause the collar to push on the platen to align the platen and the opening of the irradiation chamber to cause the irradiation target to sealingly engage with the irradiation chamber.

20. The method of claim 19, wherein the collar defines an aperture surrounded by at least three arcuate slots extending around the aperture to allow the collar to deform to allow the column to move while forcing the platen against the irradiation target to facilitate alignment of the platen and the irradiation target.

21. The method of claim 19, wherein the platen is defined by an end of a holder, the holder extending between the end and an opening of a cavity formed in the holder, the cavity extending in the holder towards the platen, the collar being fastened to the opening of the cavity to allow the column to be received into the cavity via the collar, the cavity defining a groove seating a ball defining the orbicular surface such that the column is allowed to push against the ball when disposed in the cavity.

21-41. (canceled)
